(19) United States
(12) Patent Application Publication
(10) Pub. No.: US 2019/0017631 A1
(43) Pub. Date: Jan. 17, 2019

(54) CABLE ANCHORING DEVICE

(71) Applicant: KYUNG CHANG INDUSTRIAL CO., Ltd., Daegu (KR)

(72) Inventors: Kyu-Jung KIM, Daegu (KR); Tae-Hyeong KIM, Daegu (KR)

(21) Appl. No.: 16/030,968

(22) Filed: Jul. 10, 2018

(30) Foreign Application Priority Data
Jul. 12, 2017 (KR) 10-2017-0088291

(51) Int. Cl. F16L 3/12

(52) U.S. Cl. CPC F16L 3/1222

(57) ABSTRACT

A cable anchoring device which is coupled to a bracket including a catching portion may be provided. The cable anchoring device includes: a lock cap which comprises a collar portion extending in one direction; a body comprising a lock part in which a hole through which the collar portion passes and a bracket lock groove to which the bracket is fixed are formed; a cap which is coupled to the body; and a pressing member which is disposed between the lock cap and the cap, wherein, when the body is inserted into the bracket, the lock cap is moved by the pressing member and the collar portion contacts a first surface and a second surface of the catching portion, so that the cable anchoring device is fixed to the bracket.

### BACKGROUND

### Field

The present disclosure relates to a cable anchoring device and more particularly to a cable anchoring device which is coupled to a bracket of a vehicle.

### Description of the Related Art

A cable anchoring device is used to anchor various control cables within a vehicle, etc.

Generally, a plurality of various kinds of cables are installed in machinery such as a vehicle, etc. Here, for the purpose of preventing the cable installed in the machinery such as a vehicle, etc., from being bent or being worn out due to friction, a cable anchoring device guiding the cable is employed. Here, by using the cable anchoring device, the cable is coupled to a bracket fixed to the body of the vehicle. Particularly, a cable anchoring device to be fastened to a U-shaped bracket has a lock protrusion shape.

However, in the past, when the cable is coupled to the bracket, a member which is inserted into a bracket like a clip, and a separate member that is separated from the said member have been used in order to prevent the cable from being separated from the bracket. Due to the use of the separate member, the number of the parts of the cable anchoring device becomes larger, so that the manufacturing cost becomes higher and the separate member may be lost during the coupling/separating process.

Also, in general, in the cable anchoring device, a lock protrusion of some members of the cable anchoring device is fixed in contact with a bracket. Here, when an external force is applied to the cable anchoring device, the lock protrusion of some members of the cable anchoring device is easily damaged because the rigidity of the lock protrusion of some members of the cable anchoring device is not ensured. In the past, another member for ensuring the rigidity of the lock protrusion of some members of the cable anchoring device has been added. However, this causes the increase in the number of parts and increase in manufacturing cost.

Accordingly, there is a demand for researching the cable anchoring device capable of obtaining the rigidity of the lock protrusion of some members of the cable anchoring device without using the separate member.

### SUMMARY

### Technical Problem

The present invention provides a cable anchoring device capable of reducing the number of parts because no separate member is used.

The present invention provides the cable anchoring device capable of obtaining the rigidity even without using the separate member.

### Technical Solution

One embodiment is a cable anchoring device 10 which is coupled to a bracket comprising a catching portion may be provided. The cable anchoring device includes: a lock cap which comprises a collar portion extending in one direction; a body comprising a lock part in which a hole through which the collar portion passes and a bracket lock groove to which the bracket is fixed are formed; a cap which is coupled to the body; and a pressing member which is disposed between the lock cap and the cap, wherein, when the body is inserted into the bracket, the lock cap is moved by the pressing member and the collar portion contacts a first surface and a second surface of the catching portion, so that the cable anchoring device is fixed to the bracket. The cable anchoring device may further include a cable socket which passes through the body in the longitudinal direction of the body.

The collar portion may include an inner collar portion which extends in the one direction and an outer collar portion which extends in the one direction of the inner collar portion and is formed on the outside of the inner collar portion in such a way as to be spaced apart from the inner collar portion. The hole may include an inner hole portion through which the inner collar portion passes and an outer hole portion through which the outer collar portion passes.

The catching portion may be a groove formed concave on one side of the bracket. An inner surface of the outer collar portion contacts the first surface of the catching portion, and an outer surface of the outer collar portion contacts the second surface of the catching portion, so that the cable anchoring device can be fixed to the bracket.

The catching portion may be a groove formed convex on one side of the bracket. An outer surface of the inner collar portion contacts the first surface of the catching portion, and an inner surface of the outer collar portion contacts the second surface of the catching portion, so that the cable anchoring device can be fixed to the bracket.

The inner collar portion may include a plurality of inner collars arranged in a circular form. The plurality of inner collars may be spaced apart from each other such that a gap is formed between the adjacent inner collars. The outer collar portion may include a plurality of outer collars which are circularly arranged to have the same central axis as a central axis of the plurality of inner collars. The plurality of outer collars may be spaced apart from each other to cover the gap.

The inner hole portion may include a plurality of inner holes corresponding to the plurality of inner collars. The outer hole portion 237 may include a plurality of outer holes corresponding to the plurality of outer collars. The positions of the plurality of inner holes may correspond to the positions of the plurality of inner collars respectively. The positions of the plurality of outer holes may correspond to the positions of the plurality of outer collars respectively.

The body may include a fastening protrusion which protrudes from an outer circumferential surface thereof. The cap may include a protrusion hole to which the fastening protrusion is fastened.

One or more convex portions may be formed on an inner circumferential surface of the lock cap in the longitudinal direction of the lock cap. One or more concave portions in which the convex portion is fitted may be formed on an outer circumferential surface of the cap.

### Advantageous Effects

According to the embodiment of the present invention, it is possible to reduce the number of parts because no separate member is used.

According to the embodiment of the present invention, it is possible to obtain the rigidity even without using the separate member.

### BRIEF DESCRIPTION OF THE DRAWINGS

FIG. 1 is a perspective view of a cable anchoring device according to an embodiment of the present invention;

FIG. 2 is an exploded view of the cable anchoring device according to the embodiment;

FIGS. 3 to 5 are views showing a body shown in FIG. 2;

FIGS. 6 to 10 are views showing a lock cap shown in FIG. 2;

FIGS. 11 to 13 are views for describing a cap 500;

FIG. 14 is a view for describing the coupling of the body and the lock cap;

FIG. 15 is a view for describing the coupling of the body and a cap;

FIG. 16 is a view showing a coupled state of the lock cap and the cap when viewed from the right;

FIGS. 17 to 19 are views for describing a bracket according to a first embodiment, which is used in the cable anchoring device according to the embodiment;

FIGS. 20 to 26 are views for describing the coupling process of the cable anchoring device and the bracket according to the first embodiment;

FIGS. 27 to 29 are views for describing a bracket according to a second embodiment, which is used in the cable anchoring device according to the embodiment;

FIGS. 30 to 36 are views for describing the coupling process of the cable anchoring device and the bracket according to the second embodiment.

### DETAILED DESCRIPTION

An embodiment of the present invention will be described in detail with reference to the accompanying drawings. In the components of the present invention, detailed descriptions of what can be clearly understood and easily carried into practice through a prior art by those skilled in the art will be omitted to avoid making the subject matter of the present invention unclear.

### Embodiment

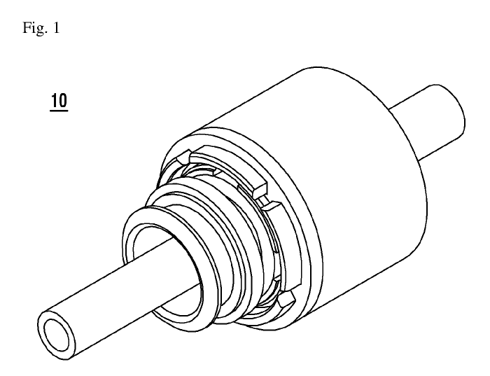

Hereafter, a cable anchoring device 10 according to an embodiment will be described with reference to FIGS. 1 to 15.

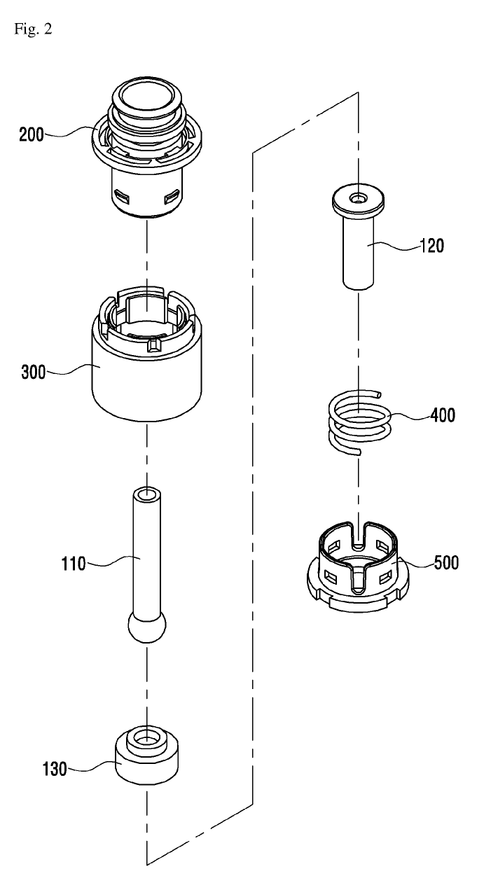

FIG. 1 is a perspective view of the cable anchoring device according to the embodiment of the present invention. FIG. 2 is an exploded view of the cable anchoring device according to the embodiment of the present invention.

Referring to FIGS. 1 and 2, the cable anchoring device 10 according to the embodiment of the present invention includes a body 200, a lock cap 300, a pressing member 400, and a cap 500. Also, the cable anchoring device 10 may further include a cable socket including a guide pipe 110, a lock pipe 120, and a damper 130.

### Body 200

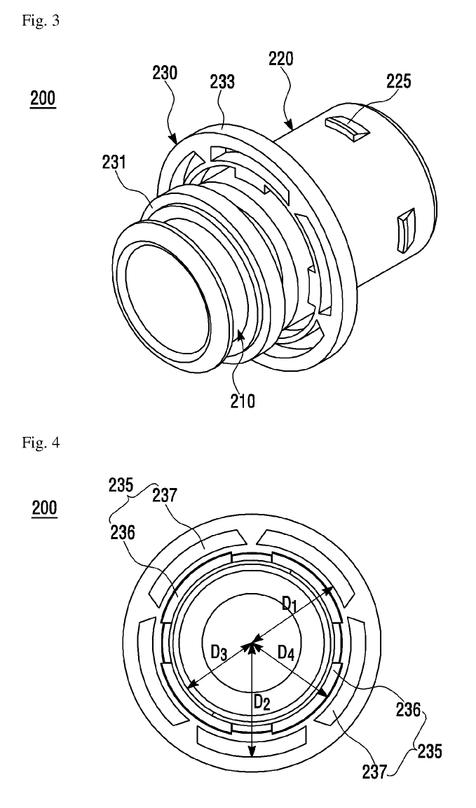

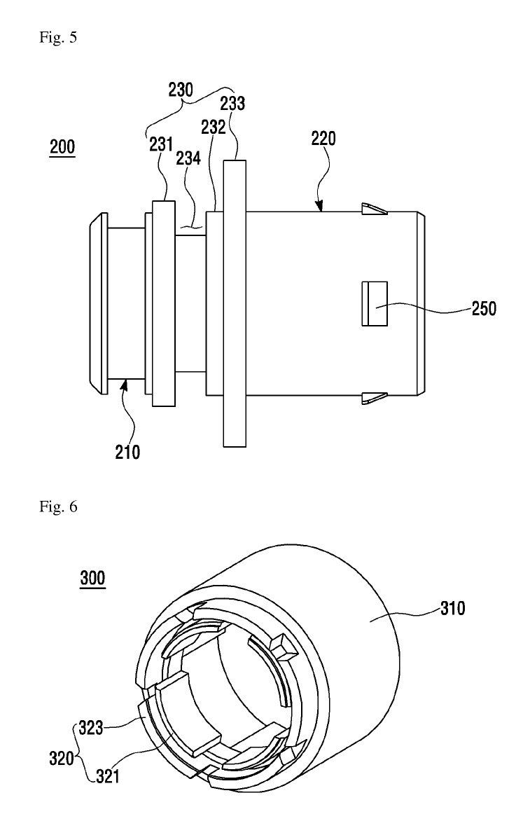

FIGS. 3 to 5 are views showing the body shown in FIG. 2 Specifically, FIG. 3 is a perspective view of the body. FIG. 4 is a view of the body when viewed from the right. FIG. 5 is a side view of the body.

Referring to FIGS. 3 to 5, the body 200 has a cylindrical tubular shape. The cable socket to be described below is inserted and pushed into the body 200.

The body 200 includes one end portion 210, the other end portion 220, and a lock part 230.

The other end portion 220 includes a fastening protrusion 225. The fastening protrusion 225 is formed to protrude from the outer circumferential surface of the other end portion 220. Though four fastening protrusions 225 are shown in the drawing, the number of fastening protrusions 225 is not necessarily limited to this. One or more fastening protrusions 225 can be provided so long as the cap 500 can serve to prevent the cap 500 from being easily separated from the body 200. The fastening protrusion 225 has an inclined portion such that the thickness of the fastening protrusion 225 increases toward the end of the other end portion 220. Therefore, when the cap 500 is coupled to the other end portion 220, the fastening protrusion 225 serves to prevent the coupled cap 500 from being easily separated from the end portion 210 of the body 200 toward the other end portion 220.

The lock part 230 is formed between the end portion 210 and the other end portion 220. The lock part 230 includes a bracket lock groove 234 which has a size sufficient to allow below-described brackets 600 and 600′ to be fitted and fixed thereto. Also, the lock part 230 includes a first lock protrusion 231 and a second lock protrusion 232, which are separated by the bracket lock groove 234, and a third lock protrusion 233 formed on the second lock protrusion 232.

The first lock protrusion 231 is located close to the end portion 210 with respect to the bracket lock groove 234. The outer diameter of the first lock protrusion 231 may be larger than the outer diameter of the end portion 210.

The second lock protrusion 232 is located close to the other end portion 220 with respect to the bracket lock groove 234. The outer diameter of the second lock protrusion 232 is equal to the outer diameter of the other end portion 220.

A hole 235 through which a below-describe collar portion 320 of the lock cap 300 passes is formed in the third lock protrusion 233. Specifically, the hole 235 includes an inner hole portion 236 through which an inner collar portion 321 of the collar portion 320 passes, and an outer hole portion 237 through which an outer collar portion 323 of the collar portion 320 passes.

Here, although four inner hole portions 236 and five outer hole portions 237 are shown in the drawing, the number of the inner hole portions 236 and the number of the outer hole portions 237 are not necessarily limited to this. One or more inner hole portions 236 and one or more outer hole portions 237 may be provided. The number of the inner hole portions 236 and the number of the outer hole portions 237 may be equal to or different from each other. The number of the inner hole portions 236 may be equal to the number of the inner collar portions 321 of the lock cap 300 or may be greater than the number of the inner collar portions 321 of the lock cap 300. The number of the outer hole portions 237 may be equal to the number of the outer collar portions 323 of the lock cap 300 or may be greater than the number of the outer collar portions 323 of the lock cap 300.

### Lock Cap 300

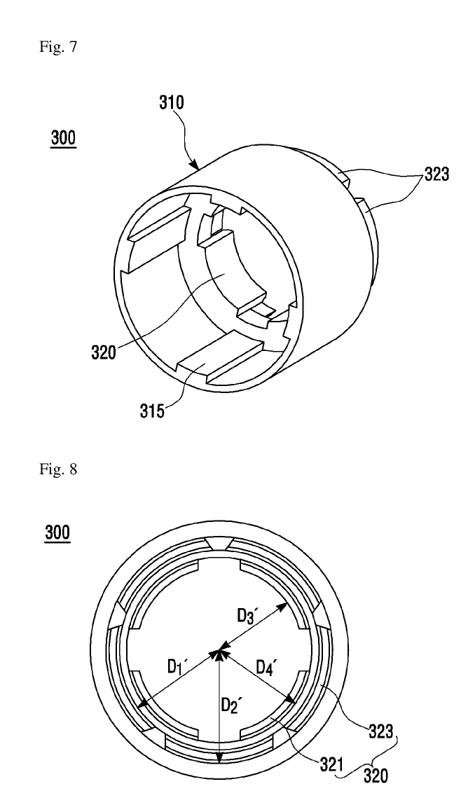

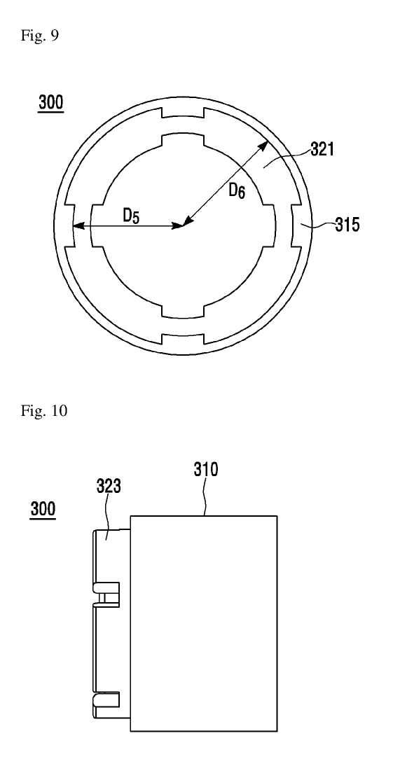

FIGS. 6 to 10 are views showing the lock cap shown in FIG. 2. Specifically, FIG. 6 is a left side perspective view of the lock cap. FIG. 7 is a right side perspective view of the lock cap. FIG. 8 is a view of the lock cap when viewed from the left side. FIG. 9 is a view of the lock cap when viewed from the right side. FIG. 10 is a side view of the lock cap.

Referring to FIGS. 6 to 10, the lock cap 300 is formed to have an annular donut shape. As shown in FIG. 2, the other end portion of the body 200 is inserted and pushed in a direction from an end portion of the lock cap 300 to the other end portion of the lock cap 300.

Specifically, the lock cap 300 includes a body portion 310 and the collar portion 320 which extends in one direction. Specifically, the collar portion 320 includes an inner collar portion 321 and an outer collar portion 323.

The outer circumferential surface of the body portion 310 may be flat as shown in the drawing. A groove or a protrusion may be formed on the outer circumferential surface of the body portion 310 at a regular interval to increase a frictional force between the body portion 310 and the user's hand, etc.

The inner collar portion 321 is formed to extend from the body portion 310 in one direction of the lock cap 300. The outer collar portion 323 extends from the body portion 310 in one direction of the lock cap 300 and is formed on the outside of the inner collar portion 321 in such a way as to be spaced apart from the inner collar portion 321.

The inner collar portion 321 is formed to be inserted and pushed into the inner hole portion 236 of the third lock protrusion 233, and the outer collar portion 323 is formed to be inserted and pushed into the outer hole portion 237 of the third lock protrusion 233. Specifically, referring to FIGS. 4 and 8, a distance D1′ from the widthwise central axis of the lock cap 300 to the inner surface of the outer collar portion 323 may be equal to or greater than a distance D1 from the widthwise central axis of the body 200 to the inner surface of the outer hole portion 237. A distance D2′ from the widthwise central axis of the lock cap 300 to the outer surface of the outer collar portion 323 may be equal to or less than a distance D2 from the widthwise central axis of the body 200 to the outer surface of the outer hole portion 237. Further, a distance D3′ from the widthwise central axis of the lock cap 300 to the inner surface of the inner collar portion 321 may be equal to or greater than a distance D3 from the widthwise central axis of the body 200 to the inner surface of the inner hole portion 236. A distance D4′ from the widthwise central axis of the lock cap 300 to the outer surface of the inner collar portion 321 may be equal to or less than a distance D4 from the widthwise central axis of the body 200 to the outer surface of the inner hole portion 236. The distance D4′ corresponds to a distance from the widthwise central axis of a mounting groove 620 to the inner surface of the mounting groove 620. Therefore, the inner collar portion 321 has a shape which can be inserted and pushed into the inner hole portion 236 of the third lock protrusion 233, and the outer collar portion 323 has a shape which can be inserted and pushed into the outer hole portion 237 of the third lock protrusion 233.

The outer surface of the inner collar portion 321 may be inclined such that the thickness of the inner collar portion 321 increases in a direction from the end portion 210 to the other end portion 220 of the body 200 in accordance with the shape of the below-described brackets 600 and 600′. Likewise, the outer surface of the outer collar portion 323 may be inclined such that the thickness of the outer collar portion 323 increases in a direction from the end portion 210 to the other end portion 220 of the body 200 in accordance with the shape of the brackets 600 and 600′.

The inner collar portion 321 includes a plurality of inner collars arranged in a circular form, and the plurality of inner collars may be spaced apart from each other such that a gap is formed between adjacent inner collars. The outer collar portion 323 includes a plurality of outer collars which are circularly arranged to have the same central axis as the central axis of the plurality of inner collars, and the plurality of outer collars are spaced apart from each other to cover the gap between adjacent inner collars. That is, when the lock cap 300 is viewed from the outside of the lock cap 300, the inner surface of the inner collar portion 321 and the inner surface of the outer collar portion 323 may not be visible by the plurality of inner collars and the plurality of outer collars. For example, though not shown in the drawing, when the inner collar portion 321 includes four inner collars, four outer collars may be arranged to cover the four gaps between the four inner collars respectively. Here, the inner hole portion 236 includes a plurality of inner holes corresponding to the plurality of inner collars. The positions of the plurality of inner holes may correspond to the positions of the plurality of inner collars respectively. The outer hole portion 237 includes a plurality of outer holes corresponding to the plurality of outer collars. The positions of the plurality of outer holes may correspond to the positions of the plurality of outer collars respectively.

As such, the inner collar portion 321 and the outer collar portion 323 of the lock cap 300 are formed to be overlapped with each other in the circumferential direction of 360°. Therefore, the cable anchoring device 10 and the brackets 600 and 600′ can be coupled easily and quickly to each other without any regulation because the cable anchoring device 10 has no assembly orientation.

One or more convex portions 315 may be formed on the inner circumferential surface of the body portion 310 in the longitudinal direction of the body portion 310. The one or more convex portions 315 has a shape corresponding to that of a below-described concave portion 515 of the cap 500. The convex portion 315 will be described together with the cap 500 below.

### Pressing Member 400

Referring to FIG. 2, the pressing member 400 is arranged between the lock cap 300 and the cap 500. Specifically, the pressing member 400 may be a spring formed by winding in the form of a coil a string material having a circular or polygonal cross section. Here, the pressing member 400 is not limited to the spring and includes any member capable of pressing the lock cap 300 in a direction from the other end portion 220 to the end portion 210 of the body 200. When the pressing member 400 is a spring, the pressing member 400 is wound on the outer circumferential surface of the other end portion 220 of the body 200.

### Cap 500

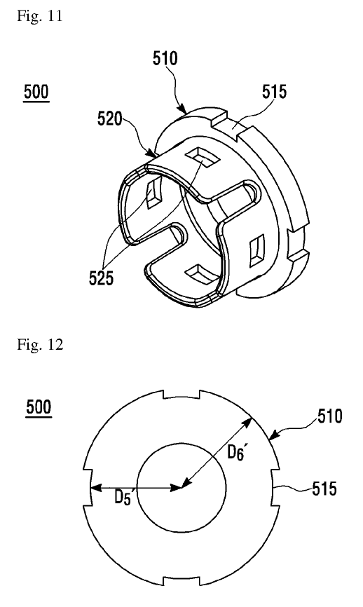

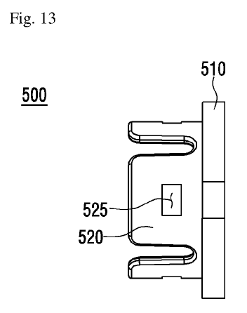

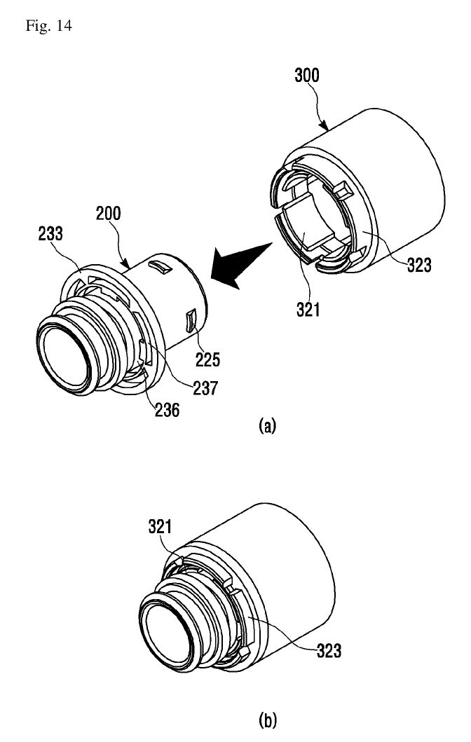

FIGS. 11 to 13 are views for describing the cap 500. Specifically, FIG. 11 is a perspective view of the cap 500. FIG. 12 is a view of the cap 500 when viewed from the right. FIG. 13 is a side view of the cap 500.

Referring to FIGS. 11 to 13, the cap 500 is coupled to the body 200. Specifically, the cap 500 has a shape corresponding to the other end portion of the lock cap 300 and is, as shown in FIG. 2, inserted in a direction from the other end portion of the lock cap 300 to the end portion of the lock cap 300. When the cap 500 is inserted in the direction from the other end portion of the lock cap 300 to the end portion of the lock cap 300, the lock cap 300 can move by a predetermined length in the forward and backward direction with respect to the cap 500 in the longitudinal direction of the convex portion 315 of the body portion 310. Here, the predetermined length corresponds to the lengths of the inner collar portion 321 and the outer collar portion 323. The predetermined length will be described in detail later.

The cap 500 includes a base 510 and a protrusion 520.

The base 510 has a circular shape having a predetermined thickness. One or more concave portions 515 are formed on the outer circumferential surface of the base 510. The concave portion 515 has a shape corresponding to the convex portion 315 formed on the inner circumferential surface of the body portion 310 of the lock cap 300. Specifically, referring to FIGS. 9 and 12, a distance D5′ from the widthwise central axis of the cap 500 to the concave portion 515 may be equal to or less than a distance D5 from the widthwise central axis of the lock cap 300 to the convex portion 315. A distance D6′ from the widthwise central axis of the cap 500 to the outer surface of the base 510 may be equal to or less than a distance D6 from the widthwise central axis of the lock cap 300 to the inner surface of the body portion 310. The number of the concave portions 515 may be equal to or greater than the number of the convex portions 315. The convex portion 315 of the body portion 310 is fitted in the concave portion 515 of the base 510.

The protrusion 520 protrudes from the base 510 in the direction toward the end portion 210 of the body 200. The protrusion 520 is positioned to contact the outer circumferential surface of the other end portion 220 of the body 200. One or more protrusions 520 can be provided, and preferably the number of the protrusions 520 may be equal to the number of the fastening protrusions 225 of the other end portion 220 of the body 200. A fastening protrusion hole 525 having a sufficient size to allow the fastening protrusion 225 to be fastened thereto is formed in each of the protrusions 520. That is, when the cap 500 is inserted into the other end portion 220 of the body 200, the protrusion 520 of the cap 500 is elastically transformed outward along the inclined surface of the fastening protrusion 225 of the other end portion 220 of the body 200. At this time, when the fastening protrusion 225 meets the protrusion hole 525 of the protrusion 520, the protrusion 520 of the cap 500 returns to its original shape. Therefore, the fastening protrusion 225 of the body 200 can be fastened to the protrusion hole 525 of the protrusion 520. Due to this fastening, the cap 500 is not easily separated from the body 200.

### Cable Socket

Referring to FIG. 2, the cable socket passes through the body 200 in the longitudinal direction of the body 200. The cable socket may include the guide pipe 110, the lock pipe 120, and the damper 130.

The guide pipe 110 has a cylindrical tubular shape. A core (not shown) of a control cable (not shown) is inserted and pushed into the guide pipe 110. The diameter of the guide pipe 110 is less than the inner diameter of the body 200. Therefore, the guide pipe 110 is inserted into the body 200. Here, the inserted core of the control cable may slide within the guide pipe 110 in a longitudinal direction of the guide pipe 110.

The lock pipe 120 has a cylindrical tubular shape. An outer of the control cable is inserted and pushed into the lock pipe 120. The diameter of the lock pipe 120 is less than the inner diameter of the body 200. Therefore, the lock pipe 120 is inserted into the body 200.

The damper 130 has a receiving space formed therein. An end of the guide pipe 110 and an end of the lock pipe 120 are disposed in the receiving space.

Here, though not shown in the drawings, the end of the guide pipe 110 and the end of the lock pipe 120 are disposed separately from each other in the receiving space of the damper 130.

FIG. 14 is a view for describing the coupling of the body and the lock cap.

Referring to FIG. 14, the lock cap 300 is coupled to the other end portion 220 of the body 200. Here, the inner collar portion 321 of the lock cap 300 passes through not only the inner hole portion 236 of the third lock protrusion 233 of the lock part 230 of the body 200, but also the outer hole portion 237 of the third lock protrusion 233 of the lock part 230 of the body 200. The length by which the inner collar portion 321 passes through the inner hole portion 236 varies depending on the position of the lock cap 300. As with the inner collar portion 321, the length by which the outer collar portion 323 passes through the outer hole portion 237 also varies depending on the position of the lock cap 300.

As such, in the cable anchoring device 10 according to the embodiment, the inner collar portion 321 and the outer collar portion 323 of the lock cap 300 pass through the inner hole portion 236 and the outer hole portion 237 respectively. Therefore, when the cable anchoring device 10 is fastened to the brackets 600 and 600′, the rigidity of the inner collar portion 321 and the rigidity of the outer collar portion 323 can be ensured because the inner collar portion 321 and the outer collar portion 323 of the lock cap 300 are in contact with the inner hole portion 236 and the outer hole portion 237 at the time of engine rolling.

Also, in the cable anchoring device 10 according to the embodiment, the rigidity of the inner collar portion 321 and the rigidity of the outer collar portion 323 can be ensured by the small number of parts of the body 200 and the lock cap 300 alone.

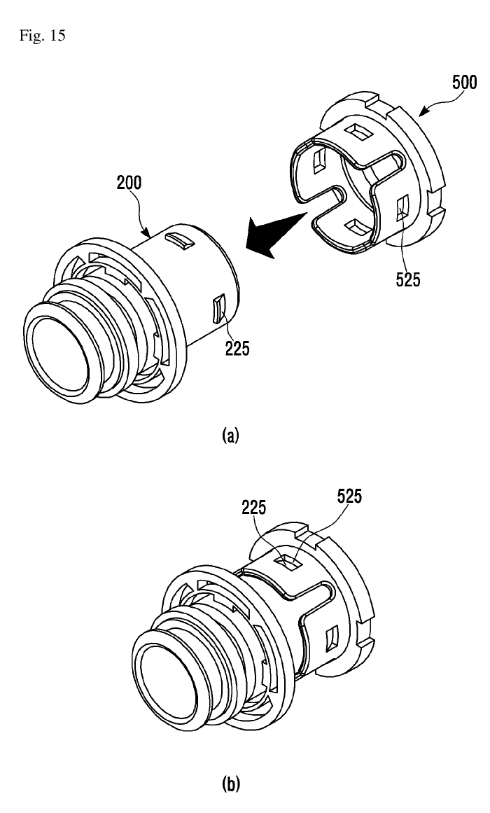

FIG. 15 is a view for describing the coupling of the body and the cap. Here, the lock cap 300 and the pressing member 400 are omitted for the description of the coupling of the body 200 and the cap 500.

Referring to FIG. 15, the cap 500 is coupled to the other end portion 220 of the body 200. Here, the fastening protrusion 225 of the other end portion 220 of the body 200 is fastened to the protrusion hole 525 of the protrusion 520 of the cap 500. Therefore, the movement of the cap 500 in the direction toward the other side of the body 200 is limited by the contact of one side of the fastening protrusion 225 with the inner side of the protrusion hole 525. The movement of the cap 500 in the direction toward one side of the body 200 is limited by the contact of the end of the base 510 of the cap 500 with the end of the other end portion 220 of the body 200.

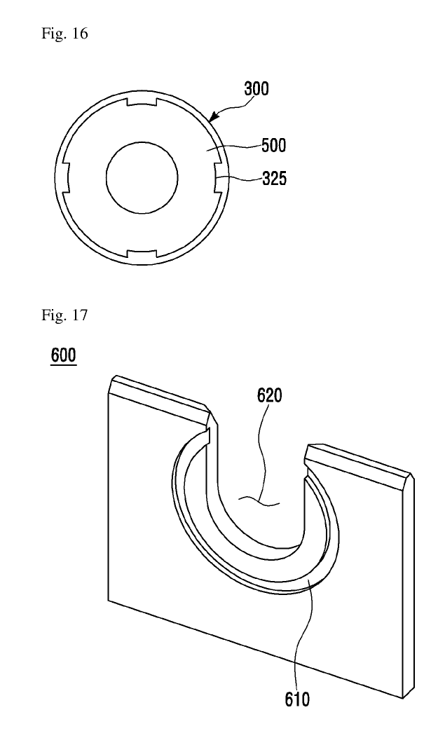

FIG. 16 is a view showing a coupled state of the lock cap and the cap when viewed from the right.

Referring to FIG. 16, when the cap 500 is inserted into the other end portion of the lock cap 300, the number of the concave portions 515 is equal to the number of the convex portions 315 such that the other end portion of the lock cap 300 is completely blocked. The shape of the convex portion 515 and the shape of the convex portion 315 can correspond to each other.

Therefore, since the other end portion of the lock cap 300 can be completely blocked by the cap 500, there is an advantage that the introduction of dust or external contaminants which may enter the other end portion of the lock cap 300 can be prevented.

### Bracket 600 according to a First Embodiment

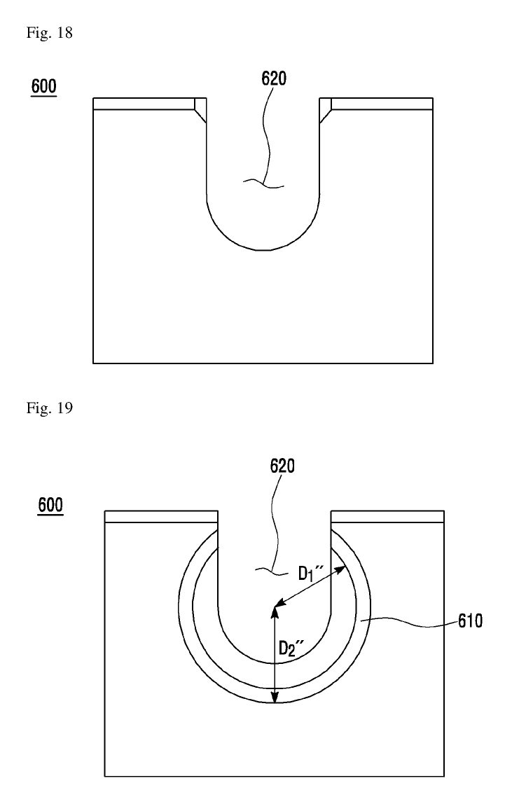

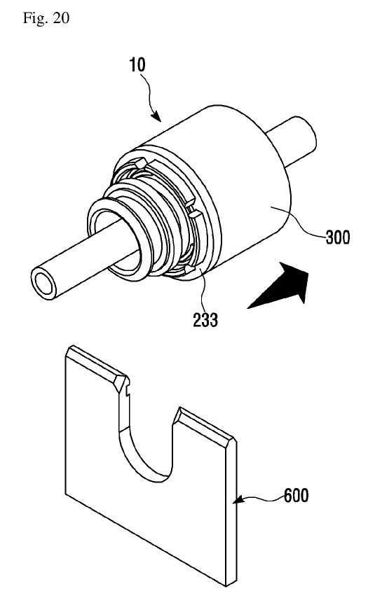

FIGS. 17 to 19 are views for describing a bracket according to the first embodiment, which is used in the cable anchoring device according to the embodiment. Specifically, FIG. 17 is a perspective view of the bracket 600. FIG. 18 is a view of the bracket 600 when viewed from the left side. FIG. 19 is a view of the bracket 600 when viewed from the right side.

Referring to FIGS. 17 to 19, a catching portion 610 and the mounting groove 620 are formed in the bracket according to the first embodiment.

The catching portion 610 is a groove formed concave on one side of the bracket 600. The catching portion 610 may be circular. The position of the catching portion 610 corresponds to the outer collar portion 323 of the lock cap 300. That is, referring to FIGS. 8 and 19, a distance D1″ from the widthwise central axis of the cable anchoring device 10 disposed in the bracket 600 to the inner surface of the catching portion 610 may be equal to or less than the distance D1 from the widthwise central axis of the lock cap 300 to the inner surface of the outer collar portion 323. Also, a distance D2″ from the widthwise central axis of the cable anchoring device 10 disposed in the bracket 600 to the outer surface of the catching portion 610 may be equal to or greater than a distance D2 from the central axis of the lock cap 300 to the outer surface of the outer collar portion 323.

Therefore, the outer collar portion 323 of the lock cap 300 can be inserted into the catching portion 610 of the bracket 600.

The mounting groove 620 is formed concave inward from the top surface of the bracket 600. How concave the mounting groove 620 is corresponds to the bracket lock groove 234 of the lock part 230 of the body 200. That is, a distance from the widthwise central axis of the bracket lock groove 234 of the body 200 to the inside of the bracket lock groove 234 may be equal to or less than a distance from the widthwise central axis of the cable anchoring device 10 disposed in the bracket 600 to the inner surface of the mounting groove 620.

The cable anchoring device 10 can be inserted into the mounting groove 620 of the bracket 600, and the bracket 600 can be inserted into the bracket lock groove 234 of the cable anchoring device 10.

Hereinafter, the coupling process of the cable anchoring device 10 and the bracket 600 will be described with reference to FIGS. 20 to 26 in accordance with the embodiment of the present invention.

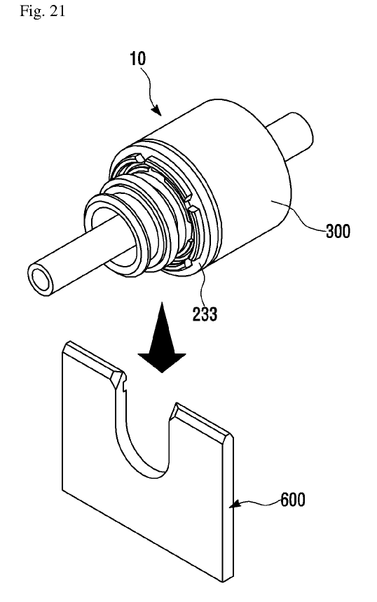

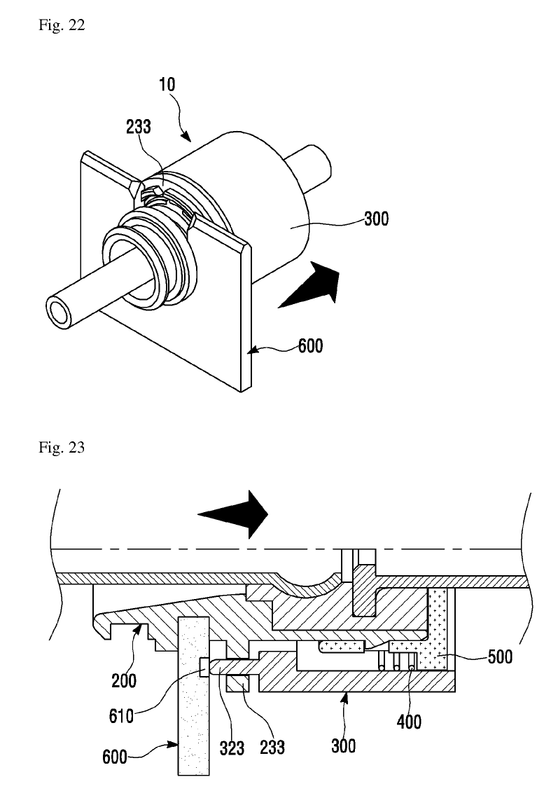

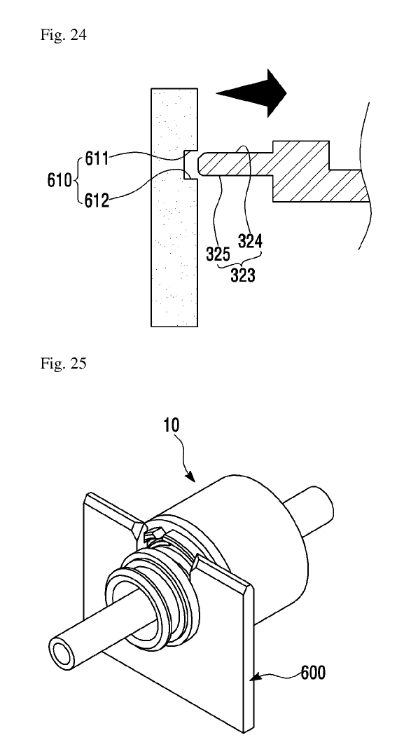

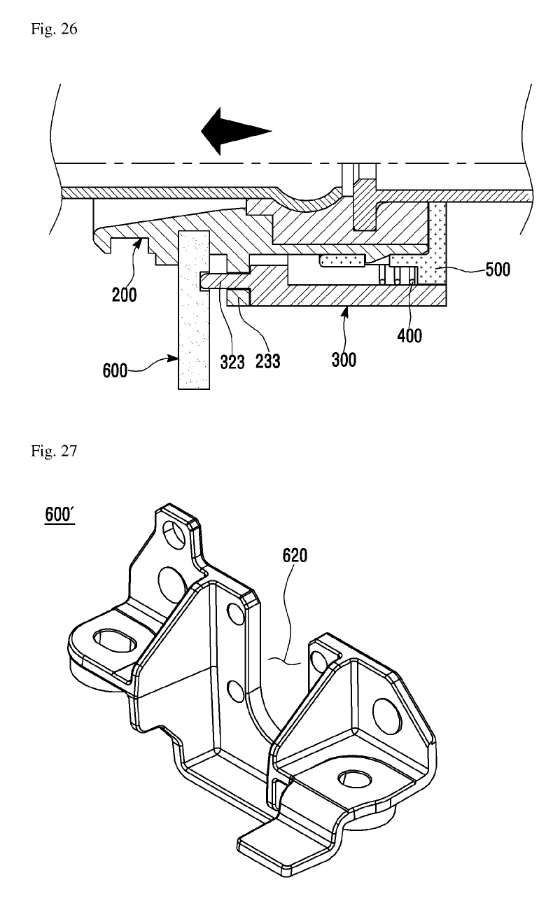

FIGS. 20 to 26 are views for describing the coupling process of the cable anchoring device and the bracket according to the first embodiment. Specifically, FIG. 20 shows a state where the cable anchoring device 10 and the bracket 600 have been separated from each other. FIG. 21 shows a state where the cable anchoring device 10 can be inserted into the mounting groove 620 of the bracket by applying an external force to the lock cap 300 of the cable anchoring device 10. FIG. 22 shows a state where the cable anchoring device has been inserted into the mounting groove 620 in the state where an external force has been applied to the lock cap 300 of the cable anchoring device 10. FIG. 23 is a cross sectional view when what is shown in FIG. 22 is viewed from the side. FIG. 24 is an enlarged view of the lock part and the outer collar portion of FIG. 23. FIG. 25 is a view showing that the cable anchoring device 10 and the bracket 600 have been coupled to each other. FIG. 26 is a cross sectional view when what is shown in FIG. 25 is viewed from the side.

As shown in FIG. 20, without applying an external force to the lock cap 300 of the cable anchoring device 10, the inner collar portion 321 and the outer collar portion 323 of the lock cap 300 protrude toward the end portion 210 of the body part 200.

As shown in FIG. 21, when an external force is applied to the lock cap 300 of the cable anchoring device 10 in the direction of the other end portion 220 of the body 200, a gap is formed between the lock cap 300 and the body 200. The inner collar portion 321 is further inserted by as much as the formed gap into the inner hole portion 236 and the outer collar portion 323 is further inserted by as much as the formed gap into the outer hole portion 237.

When the pressing member 400 is a spring and the body portion 310 of the lock cap 300 becomes close to the base 510 of the cap 500, the pressing member 400 generates an elastic force in a direction in which the body portion 310 and the base 510 are caused to be farther away from each other because the pressing member 400 between the body portion 310 of the lock cap 300 and the base 510 of the cap 500 is in a compressed state

As shown in FIGS. 22 and 23, the cable anchoring device 10 is inserted into the mounting groove 620 of the bracket 600 while the bracket 600 is inserted into the bracket lock groove 234 of the body 200. Specifically, since the inner collar portion 321 has been further inserted into the inner hole portion 236 and the outer collar portion 323 has been further inserted into the outer hole portion 237, the inner collar portion 321 and the outer collar portion 323 are not in contact with the bracket 600, so that the cable anchoring device 10 is easily inserted into the mounting groove 620 of the bracket 600.

As shown in FIGS. 25 and 26, the cable anchoring device 10 is coupled to the bracket 600. Specifically, the lock cap 300 is moved by the pressing member 400, and the outer collar portion 323 comes in contact with the catching portion 610 of the bracket 600, so that the bracket 600 is fixed.

For example, when the pressing member 400 is a spring and the cable anchoring device 10 is inserted into the mounting groove 620 of the bracket 600, the external force applied to the lock cap 300 is removed. In the cable anchoring device 10 without the external force, the body portion 310 of the lock cap 300 becomes farther away from the base 510 of the cap 500 by the elastic force of the pressing member 400, so that the outer collar portion 323 of the lock cap 300 is inserted into the catching portion 610 of the bracket 600.

When the pressing member 400 is not a spring, the body portion 310 of the lock cap 300 is caused to be farther away from the base 510 of the cap 500 by applying a separate external force, so that the outer collar portion 323 of the lock cap 300 is inserted into the catching portion 610 of the bracket 600.

Referring to FIGS. 23, 24, and 26, an inner surface 324 of the outer collar portion 323 contacts a first surface 611 of the catching portion 610, and an outer surface 325 of the outer collar portion 323 contacts a second surface 612 of the catching portion 610, so that the cable anchoring device 10 is fixed to the bracket 600. Therefore, when the body 200 is inserted into the bracket 600, the upward and downward movements of the cable anchoring device 10 are limited because the lock cap 300 is moved by the pressing member 400 and the collar portion 320 contacts the first surface 611 and the second surface 612 of the catching portion 610. In addition, the forward and backward movements of the cable anchoring device 10 is limited by the first lock protrusion 231 and the second lock protrusion 232 of the body 200.

Thus, the upward, forward, and backward movements of the cable anchoring device 10 are all limited, so that the cable anchoring device 10 and the bracket 600 are completely coupled.

Describing a process of separating the cable anchoring device 10 from the bracket 600, first, an external force is applied to the lock cap 300 of the cable anchoring device 10 in the direction of the other end portion 220 of the body 200. Then, the outer collar portion 323 of the lock cap 300 inserted into the catching portion 610 of the bracket 600 escapes, and then, the cable anchoring device 10 is separated upward from the mounting groove 620 of the bracket 600.

### Bracket 600′ according to a Second Embodiment

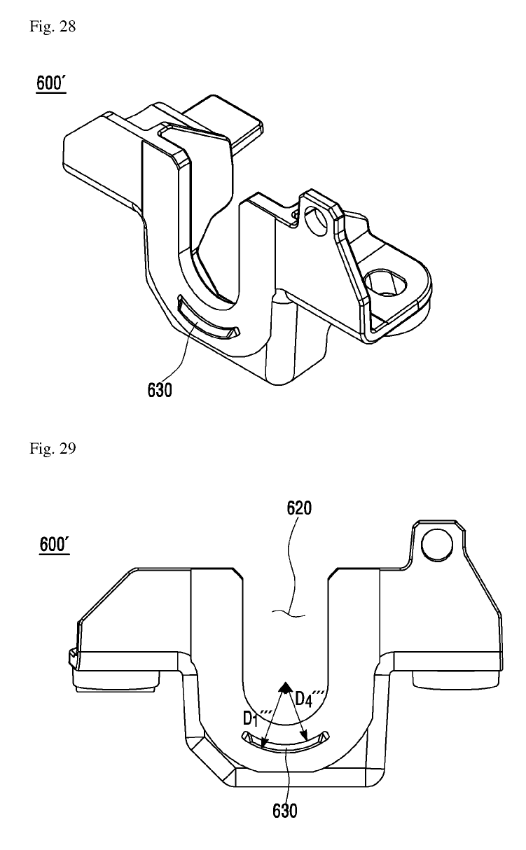

FIGS. 27 to 29 are views for describing a bracket according to the second embodiment, which is used in the cable anchoring device according to the embodiment. Specifically, FIG. 27 is a left side perspective view of the bracket 600′. FIG. 28 is a right side perspective view of the bracket 600′. FIG. 29 is a view of the bracket 600′ when viewed from the right side.

Referring to FIGS. 27 to 29, a catching portion 630 and the mounting groove 620 are formed in the bracket 600′ according to the second embodiment.

The catching portion 630 is a groove formed convex on one side of the bracket 600′. The catching portion 630 has a shape which can be caught between the inner collar portion 321 and the outer collar portion 323. The position of the catching portion 630 corresponds to the inner collar portion 321 and the outer collar portion 323 of the lock cap 300. That is, referring to FIGS. 8 and 29, a distance D1′″ from the widthwise central axis of the cable anchoring device 10 disposed in the bracket 600′ to the outer surface of the catching portion 630 may be equal to or less than the distance D1 from the widthwise central axis of the lock cap 300 to the inner surface of the outer collar portion 323. Also, a distance D4′″ from the widthwise central axis of the cable anchoring device 10 disposed in the bracket 600′ to the inner surface of the catching portion 630 may be equal to or greater than a distance D4 from the central axis of the lock cap 300 to the outer surface of the inner collar portion 321.

Therefore, the inside of the catching portion 630 of the bracket 600′ contacts the outside of the inner collar portion 321 of the lock cap 300. The outside of the catching portion 630 contacts the inside of the outer collar portion 323.

The mounting groove 620 is formed concave inward from the top surface of the bracket 600′. How concave the mounting groove 620 is corresponds to the bracket lock groove 234 of the lock part 230 of the body 200. That is, a distance from the widthwise central axis of the bracket lock groove 234 of the body 200 to the inside of the bracket lock groove 234 may be equal to or less than a distance from the widthwise central axis of the cable anchoring device 10 disposed in the bracket 600′ to the inner surface of the mounting groove 620.

The cable anchoring device 10 can be inserted into the mounting groove 620 of the bracket 600′, and the bracket 600′ can be inserted into the bracket lock groove 234 of the cable anchoring device 10.

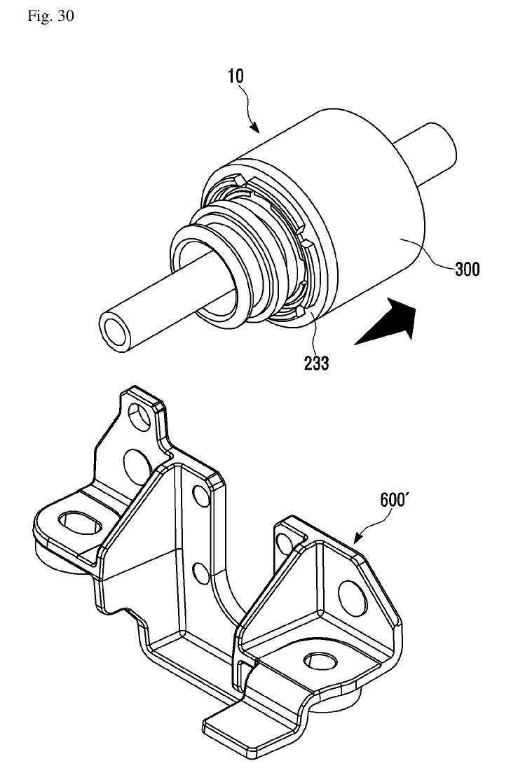

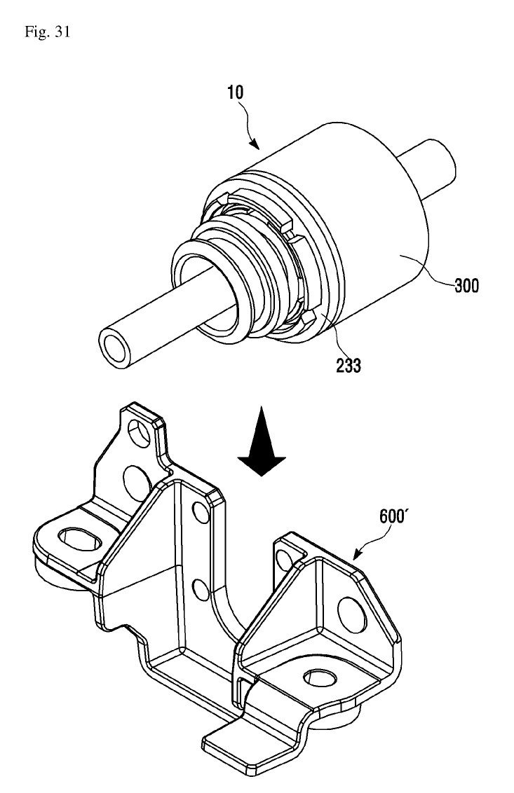

Hereinafter, the coupling process of the cable anchoring device 10 and the bracket 600′ will be described with reference to FIGS. 30 to 36 in accordance with the embodiment of the present invention.

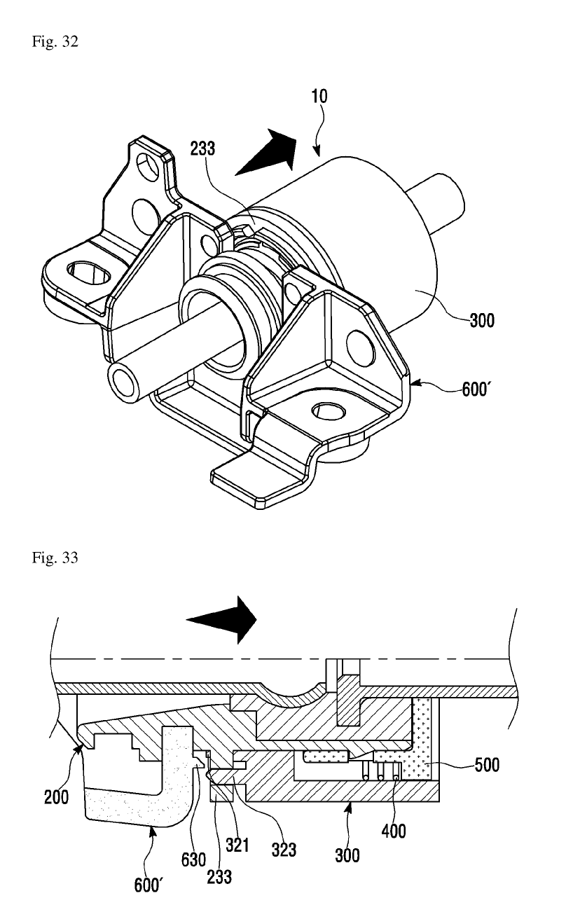

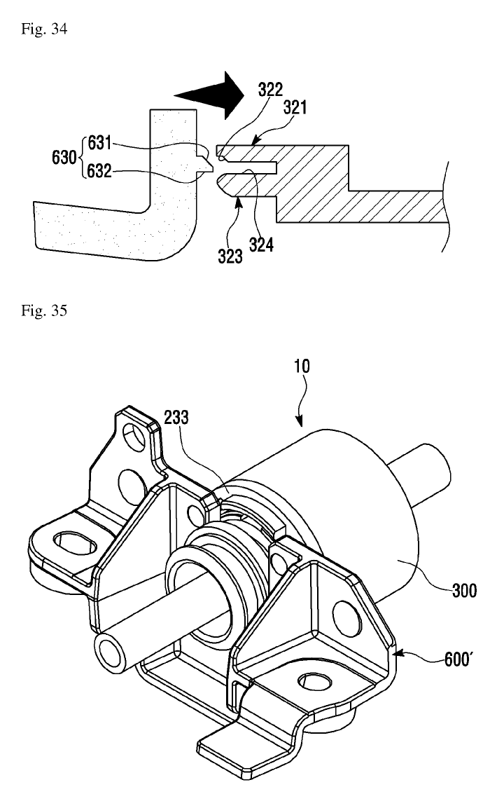

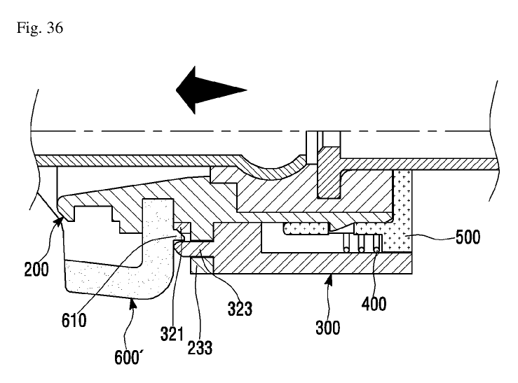

FIGS. 30 to 36 are views for describing the coupling process of the cable anchoring device and the bracket according to the second embodiment. Specifically, FIG. 30 shows a state where the cable anchoring device 10 and the bracket 600′ have been separated from each other. FIG. 31 shows a state where the cable anchoring device 10 can be inserted into the mounting groove 620 of the bracket 600′ by applying an external force to the lock cap 300 of the cable anchoring device 10. FIG. 32 shows a state where the cable anchoring device has been inserted into the mounting groove 620 in the state where an external force has been applied to the lock cap 300 of the cable anchoring device 10. FIG. 33 is a cross sectional view when what is shown in FIG. 32 is viewed from the side. FIG. 34 is an enlarged view of the lock part, the inner collar portion 321, and the outer collar portion 323 of FIG. 33. FIG. 35 is a view showing that the cable anchoring device 10 and the bracket 600′ have been coupled to each other. FIG. 36 is a cross sectional view when what is shown in FIG. 35 is viewed from the side.

As shown in FIG. 30, without applying an external force to the lock cap 300 of the cable anchoring device 10, the inner collar portion 321 and the outer collar portion 323 of the lock cap 300 protrude toward the end portion 210 of the body part 200.

As shown in FIG. 31, when an external force is applied to the lock cap 300 of the cable anchoring device 10 in the direction of the other end portion 220 of the body 200, a gap is formed between the lock cap 300 and the body 200. The inner collar portion 321 is further inserted by as much as the formed gap into the inner hole portion 236 and the outer collar portion 323 is further inserted by as much as the formed gap into the outer hole portion 237.

When the pressing member 400 is a spring and the body portion 310 of the lock cap 300 becomes close to the base 510 of the cap 500, the pressing member 400 generates an elastic force in a direction in which the body portion 310 and the base 510 are caused to be farther away from each other because the pressing member 400 between the body portion 310 of the lock cap 300 and the base 510 of the cap 500 is in a compressed state

As shown in FIGS. 32 and 33, the cable anchoring device 10 is inserted into the mounting groove 620 of the bracket 600′ while the bracket 600′ is inserted into the bracket lock groove 234 of the body 200. Specifically, since the inner collar portion 321 has been further inserted into the inner hole portion 236 and the outer collar portion 323 has been further inserted into the outer hole portion 237, the inner collar portion 321 and the outer collar portion 323 are not in contact with the bracket 600′, so that the cable anchoring device 10 is easily inserted into the mounting groove 620 of the bracket 600′.

As shown in FIGS. 35 and 36, the cable anchoring device 10 is coupled to the bracket 600′. Specifically, the lock cap 300 is moved by the pressing member 400, and the outer collar portion 323 comes in contact with the catching portion 630 of the bracket 600′, so that the bracket 600′ is fixed.

For example, when the pressing member 400 is a spring and the cable anchoring device 10 is inserted into the mounting groove 620 of the bracket 600′, the external force applied to the lock cap 300 is removed. In the cable anchoring device 10 without the external force, the body portion 310 of the lock cap 300 becomes farther away from the base 510 of the cap 500 by the elastic force of the pressing member 400, so that the catching portion 630 of the bracket 600′ is disposed between the inner collar portion 321 and the outer collar portion 323 of the lock cap 300.

When the pressing member 400 is not a spring, the body portion 310 of the lock cap 300 is caused to be farther away from the base 510 of the cap 500 by applying a separate external force, so that the catching portion 630 of the bracket 600′ is disposed between the inner collar portion 321 and the outer collar portion 323 of the lock cap 300.

Referring to FIGS. 33, 34, and 36, an outer surface 322 of the inner collar portion 321 contacts a first surface 631 of the catching portion 630, and the inner surface 324 of the outer collar portion 323 contacts a second surface 632 of the catching portion 630, so that the cable anchoring device 10 is fixed to the bracket 600′. Therefore, when the body 200 is inserted into the bracket 600′, the upward and downward movements of the cable anchoring device 10 are limited because the lock cap 300 is moved by the pressing member 400 and the collar portion 320 contacts simultaneously the first surface 631 and the second surface 632 of the catching portion 630. In addition, the forward and backward movements of the cable anchoring device 10 is limited by the first lock protrusion 231 and the second lock protrusion 232 of the body 200.

Thus, the upward, forward, and backward movements of the cable anchoring device 10 are all limited, so that the cable anchoring device 10 and the bracket 600′ are completely coupled.

Describing a process of separating the cable anchoring device 10 from the bracket 600′, first, an external force is applied to the lock cap 300 of the cable anchoring device 10 in the direction of the other end portion 220 of the body 200. Then, the inner collar portion 321 and the outer collar portion 323 of the lock cap 300, which contact the catching portion 630 of the bracket 600′, escape, and then, the cable anchoring device 10 is separated upward from the mounting groove 620 of the bracket 600′.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A cable anchoring device which is coupled to a bracket comprising a catching portion, the cable anchoring device comprising:
a lock cap which comprises a collar portion extending in one direction;
a body comprising a lock part in which a hole through which the collar portion passes and a bracket lock groove to which the bracket is fixed are formed;
a cap which is coupled to the body; and
a pressing member which is disposed between the lock cap and the cap,
wherein, when the body is inserted into the bracket, the lock cap is moved by the pressing member and the collar portion contacts a first surface and a second surface of the catching portion, so that the cable anchoring device is fixed to the bracket.

2. The cable anchoring device of claim 1, further comprising a cable socket which passes through the body in the longitudinal direction of the body.

3. The cable anchoring device of claim 1,
wherein the collar portion comprises an inner collar portion which extends in the one direction and an outer collar portion which extends in the one direction of the inner collar portion and is formed on the outside of the inner collar portion in such a way as to be spaced apart from the inner collar portion,
and wherein the hole comprises an inner hole portion through which the inner collar portion passes and an outer hole portion through which the outer collar portion passes.

4. The cable anchoring device of claim 3,
wherein the catching portion is a groove formed concave on one side of the bracket,
and wherein an inner surface of the outer collar portion contacts the first surface of the catching portion, and an outer surface 325 of the outer collar portion 323 contacts the second surface of the catching portion, so that the cable anchoring device is fixed to the bracket.

5. The cable anchoring device of claim 3,
wherein the catching portion is a groove formed convex on one side of the bracket,
and wherein an outer surface of the inner collar portion contacts the first surface of the catching portion, and an inner surface of the outer collar portion contacts the second surface of the catching portion, so that the cable anchoring device is fixed to the bracket.

6. The cable anchoring device of claim 3,
wherein the inner collar portion comprises a plurality of inner collars arranged in a circular form,
wherein the plurality of inner collars are spaced apart from each other such that a gap is formed between the adjacent inner collars,
wherein the outer collar portion comprises a plurality of outer collars which are circularly arranged to have the same central axis as a central axis of the plurality of inner collars,
and wherein the plurality of outer collars are spaced apart from each other to cover the gap.

7. The cable anchoring device of claim 4,
wherein the inner collar portion comprises a plurality of inner collars arranged in a circular form,
wherein the plurality of inner collars are spaced apart from each other such that a gap is formed between the adjacent inner collars,
wherein the outer collar portion comprises a plurality of outer collars which are circularly arranged to have the same central axis as a central axis of the plurality of inner collars,
and wherein the plurality of outer collars are spaced apart from each other to cover the gap.

8. The cable anchoring device of claim 5,
wherein the inner collar portion comprises a plurality of inner collars arranged in a circular form,
wherein the plurality of inner collars are spaced apart from each other such that a gap is formed between the adjacent inner collars,
wherein the outer collar portion comprises a plurality of outer collars which are circularly arranged to have the same central axis as a central axis of the plurality of inner collars,
and wherein the plurality of outer collars are spaced apart from each other to cover the gap.

9. The cable anchoring device of claim 6,
wherein the inner hole portion comprises a plurality of inner holes corresponding to the plurality of inner collars,
wherein the outer hole portion comprises a plurality of outer holes corresponding to the plurality of outer collars,
wherein the positions of the plurality of inner holes correspond to the positions of the plurality of inner collars respectively,
and wherein the positions of the plurality of outer holes correspond to the positions of the plurality of outer collars respectively.

10. The cable anchoring device of claim 7,
wherein the inner hole portion comprises a plurality of inner holes corresponding to the plurality of inner collars,
wherein the outer hole portion comprises a plurality of outer holes corresponding to the plurality of outer collars,
wherein the positions of the plurality of inner holes correspond to the positions of the plurality of inner collars respectively,
and wherein the positions of the plurality of outer holes correspond to the positions of the plurality of outer collars respectively.

11. The cable anchoring device of claim 8,
wherein the inner hole portion comprises a plurality of inner holes corresponding to the plurality of inner collars,
wherein the outer hole portion comprises a plurality of outer holes corresponding to the plurality of outer collars,
wherein the positions of the plurality of inner holes correspond to the positions of the plurality of inner collars respectively,
and wherein the positions of the plurality of outer holes correspond to the positions of the plurality of outer collars respectively.

12. The cable anchoring device of claim 1,
wherein the body comprises a fastening protrusion which protrudes from an outer circumferential surface thereof,
and wherein the cap comprises a protrusion hole to which the fastening protrusion is fastened.

13. The cable anchoring device of claim 1,
wherein one or more convex portions are formed on an inner circumferential surface of the lock cap in the longitudinal direction of the lock cap,
and wherein one or more concave portions in which the convex portion is fitted are formed on an outer circumferential surface of the cap.
